(19) United States
(12) Patent Application Publication
(10) Pub. No.: US 2015/0078546 A1
(43) Pub. Date: Mar. 19, 2015

(54) DIALER FOR CALL ROUTING SYSTEMS

(71) Applicant: Ipex Business Cosulting Ltd., Kiryat-Ono (IL)

(72) Inventor: Doron STANITSKY, Kiryat Ono (IL)

(73) Assignee: Ipex Business Cosulting Ltd., Kiryat-Ono (IL)

(21) Appl. No.: 14/028,569

(22) Filed: Sep. 17, 2013

(51) Int. Cl. H04M 3/51; H04M 3/523

(52) U.S. Cl. CPC H04M 3/5183; H04M 3/5235
USPC 379/265.09

(57) ABSTRACT

A method for connecting a smartphone to a telephone via a call routing system includes presenting by the smartphone of a list of destination telephones that are connectible to the smartphone via a selected call routing system. A selection of a destination telephone from the list of destination telephones is received by the smartphone. The smartphone is automatically connected to the selected destination telephone and previously entered personal information is automatically provided to the selected call routed system.

### FIELD OF THE INVENTION

The present invention relates to a dialer for a call routing system.

### BACKGROUND OF THE INVENTION

Human telephone switchboard operators, telephone receptionists, and secretaries that receive and route incoming telephone calls have largely been replaced by automated call-routing systems. In an automated call-routing system, a caller is typically answered by a recording. The recording offers the caller a choice of options (e.g., in a manner similar to a menu). For example, the options may include various departments, services, people, actions, or sources of information. The caller may input a selection of one of the options by pressing a button on a telephone keypad, or, in some cases, by speaking the option. Often, selection of one option results with another recording offering the caller another set of options (e.g., in a manner similar to a sub-menu) with regard to the first selection. For example, selection of a department may result in the caller being requested to select a service that is being requested of the selected department, or a particular sub-department or person within the selected department.

In some cases, a caller may have to listen to the entire set of options before being able to decide which option to select. In some cases, the caller is given the option of requesting repeat of a set of options, or of returning to a previous set of options. In other cases, if the caller has forgotten or missed hearing some of the options, or if none of the options appear to be relevant, the caller may have to start over (e.g., call the initial phone number again and repeat the selection process).

During the course of interacting with the call routing system, the user may be asked to input data to aid in routing the call, or in enabling the system to identify the caller or the caller's business. In a region wherein more than one language is spoken, the caller may be asked to select a language for interacting with the call routing system. For example, when calling a credit card service center, the caller may be asked to input an identification number, an account number, or part of the credit card number. When calling with regard to a vehicle (e.g., service center or motor vehicle licensing authority), the caller may be asked to enter a license number of the vehicle. When calling a subscription service center, the caller may be asked to enter a subscriber account number or a telephone number. Lack of standardization among call routing systems further adds to the inconvenience. Each call to a different call routing system presents the caller with different options. Thus, the caller must listen to the list of options each time (or at least when calling a particular call routing system for the first time).

### SUMMARY OF THE INVENTION

There is thus provided, in accordance with some embodiments of the present invention, a method for connecting a smartphone to a telephone via a call routing system, the method including: presenting by the smartphone of a list of destination telephones that are connectible to the smartphone via a selected call routing system; receiving by the smartphone a selection of a destination telephone from the list of destination telephones; automatically connecting the smartphone to the selected destination telephone; and automatically providing previously entered personal information to the selected call routed system.

Furthermore, in accordance with some embodiments of the present invention, obtaining the selection of the call routing system includes presenting a list of cooperating call routing systems.

Furthermore, in accordance with some embodiments of the present invention, obtaining the selection of the call routing system includes detecting an indication of an intention to use the smartphone to call that call routing system.

Furthermore, in accordance with some embodiments of the present invention, the indication includes selection of a telephone number of the selected call routing system from a phonebook of the smartphone.

Furthermore, in accordance with some embodiments of the present invention, the method further includes checking availability of the selected destination telephone.

Furthermore, in accordance with some embodiments of the present invention, the method further includes generating a notification of when the selected destination telephone is expected to be available.

Furthermore, in accordance with some embodiments of the present invention, the method further includes automatically connecting to the selected destination telephone when the selected destination telephone becomes available.

Furthermore, in accordance with some embodiments of the present invention, the method further includes presenting a request by the smartphone for entering the personal information.

Furthermore, in accordance with some embodiments of the present invention, the method further includes receiving the entered personal information in alphanumeric form or in vocal form.

Furthermore, in accordance with some embodiments of the present invention, a destination telephone of the list of destination telephones is labeled by a label selected from a group of label types consisting of a telephone number, a branch line, a telephone extension, a name of a person, a name of a department, and a name of a service.

There is further provided, in accordance with some embodiments of the present invention, a smartphone device including: a communication unit to communicate with a telephone; a processor configured to: obtain a selection of a call routing system; presenting a list of destination telephones that are connectible to the device via the selected call routing system; receive a selection of a destination telephone from the list of destination telephones; operate the communication unit to connect the device to the selected destination telephone; and operate the communication unit to provide previously entered personal information to the selected call routing system.

Furthermore, in accordance with some embodiments of the present invention, the processor is further configured to display a list of cooperating call routing systems on a display of the device.

Furthermore, in accordance with some embodiments of the present invention, the processor is configured to obtain the selection of the call routing system by detecting an input indication of an intention to call that call routing system.

Furthermore, in accordance with some embodiments of the present invention, the processor is configured to obtain the selection of the call routing system by detecting a selection of telephone number of the selected call routing system from a phonebook of the device.

Furthermore, in accordance with some embodiments of the present invention, the processor is further configured to check availability of the selected destination telephone.

Furthermore, in accordance with some embodiments of the present invention, the processor is further configured to generate a notification of when the selected destination telephone is expected to be available.

Furthermore, in accordance with some embodiments of the present invention, processor is further configured to operate the communication unit to connect the device to the selected destination telephone when the selected destination telephone becomes available.

Furthermore, in accordance with some embodiments of the present invention, the processor is configured to operate an output device to request entering of the personal information.

Furthermore, in accordance with some embodiments of the present invention, the processor is configured to receive the entered personal information in alphanumeric form or in vocal form.

Furthermore, in accordance with some embodiments of the present invention, a destination telephone of the list of destination telephones is labeled by a label selected from a group of label types consisting of a telephone number, a branch line, a telephone extension, a name of a person, a name of a department, and a name of a service.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 schematically illustrates a dialer for call routing systems, in accordance with an embodiment of the present invention.

FIG. 2 schematically illustrates a smartphone that is configured to run a dialer for a call routing system, in accordance with an embodiment of the present invention.

FIG. 3 is a flowchart depicting a method for operation of a dialer for a call routing system, in accordance with an embodiment of the present invention.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Embodiments of the invention may include an article such as a computer or processor readable medium, or a computer or processor storage medium, such as for example a memory, a disk drive, or a USB flash memory, encoding, including or storing instructions, e.g., computer-executable instructions, which when executed by a processor or controller, carry out methods disclosed herein.

In accordance with some embodiments of the present invention, a dialer is configured to expedite calling a call routing system. For example, the dialer may be installed as an application or program on a device with appropriate calling and processing capabilities. The device may be or include a smartphone, portable or stationary computer, or other device that is provided with both processing capability and capability to communicate via a telephone network (e.g., including a circuit board that enables placement of phone calls). As used herein, the term “smartphone” is used to refer to any such device, mobile or stationary, with telephone calling and processing capability to enable implementation of a dialer, in accordance with embodiments of the present invention. A dialer may be adapted (e.g., by installing an appropriate version or by selecting an appropriate parameter when installing a generic version) to a particular make, model, or type of smartphone.

An operator or representative of a call routing system of a cooperating organization, referred to herein as a “cooperating call routing system,” may provide a list of labeled destination telephones. A destination telephone in the list may be labeled by or as, or may include, for example, a telephone number, branch line, telephone extension, a name of a person, department, or service, or another appropriate label of a final destination of navigation of a call routing system, For example, the list may be displayed on a display screen of the smartphone. The list of destination telephones represents some or all telephones that may be reached using the call routing system. The labels may be sufficiently descriptive so as to enable a caller to immediately select a destination telephone from the list. The cooperating organization may subscribe to a service for providing expedited dialing via the dialer to that organization's call routing system. (On the other hand, the dialer may be distributed freely to any smartphone or caller so as to enable or promote dialing to the cooperating organization.)

Selection of a destination telephone by the caller may cause the smartphone to call that destination telephone directly. Alternatively or in addition, selection of a destination telephone by the caller may enable the smartphone to automatically navigate the call routing system. For example, the smartphone may immediately select the desired option at each phase of navigation, as well as enter any required identifying information, to enable rapid connection with the desired destination telephone. In some cases, an appropriate interface may be provided to the smartphone or to the cooperating call routing system (e.g., by a service for providing expedited dialing via the dialer to call routing systems) to enable the dialer to interact with the call routing system.

A caller, prior to accessing or operating the dialer for the first time, or for the first time in a particular context (e.g., calling for the first time with regard to a particular subject, such as a particular service or service with regard to a particular item or type of item) may be required to enter initializing information. The initializing information may include an alphanumeric identification for the caller and identification to be used in accessing the dialer (e.g., a caller-defined account name, account number, or password). Further initializing information may include information that may be required during operation of the dialer (e.g., that are commonly required by several organizations, or that are required to obtain a particular service). Such information may include a designation (e.g., address, city, zip code, or other identifier) of the caller's residence, office or business, of items that are in the possession of the caller (e.g., vehicle license number, or a name, serial, or model number of an item owned), credit card or bank account number and expiration date, date of birth, telephone number (e.g., of a telephone other than that used to operate the dialer), a preferred language, or other information. Upon subsequent access to the dialer, the caller may be required to enter only sufficient information to ensure the identity of the caller (e.g., password or other identifying information). In some cases (e.g., where a high level of security is not required), a caller may be associated with a particular smartphone such that a telephone call made via the dialer on a smartphone may be assumed to be made on behalf of the associated caller (e.g., unless otherwise indicated by the caller).

For example, a caller may initiate a telephone call by running or activating a dialer application on a smartphone. The dialer may require the caller to enter identifying information, or to verify that the caller is the caller that is associated with that smartphone. The dialer may then present the caller with a list of cooperating call routing systems. The caller may select one of the cooperating call routing systems. The dialer may then present the caller with a list or tree (e.g., in a form similar to that of a menu) of possible call destinations. When presenting the possible call destinations, some or all of the destinations may be indicated as unavailable (e.g., after working hours for one or more departments of an organization with which the call routing system is associated). The caller may select one of the (available) call destinations. The dialer then connects the caller with requested call destination.

As another example, the dialer may run as a background application. A caller may initiate a telephone call in a conventional manner, e.g., by entering a phone number or by selecting a call destination or phone number from a directory or phonebook application or website. The dialer may recognize the selected call destination as a cooperating call routing system. The dialer may then present the caller with a list or tree of possible call destinations within the dialed organization. The caller may select one of the call destinations and the dialer may connect the caller with requested call destination.

A dialer for a call routing system, in accordance with some embodiments of the present invention, may be advantageous. Use of the dialer in calling a destination telephone may be more efficient than conventional navigation of a call routing system. When calling using the dialer, the caller selects the destination telephone before calling. Selection of a destination telephone may require a few seconds (e.g., no more than 20 seconds, or as few as about 10 seconds) from activation of the dialer. Thus, there is no need to wait to listen to a recorded (or synthesized) message when selecting a destination (and possibly end up forgetting the first part of the message while waiting for the message to complete), as would be required when navigating the call routing system in the conventional manner (a process typically requiring several minutes of the caller's time). When so configured, the dialer may directly call the destination telephone, again saving time. In other configurations, the dialer may automatically navigate the call routing system while the user waits for an indication that the call has been connected. In such configurations, the dialer may select options in a quicker manner than would a human caller navigating the call routing system in the conventional manner. When so configured, the dialer may immediately indicate to the caller that the destination telephone is not available (e.g., is not being manned at the time of the call). When so configured, the dialer may indicate a later time when the destination telephone is scheduled to be available, and may remind the caller (e.g., via a visible or audible message) to call at the later time. When so configured, the dialer may indicate an estimated waiting time until the destination telephone is expected to be answered.

A cooperating organization may benefit when calls are made to the organization's cooperating call routing system using a dialer, in accordance with embodiments of the present invention. When a call routing system operates in the conventional manner, many callers who are short on time or patience may hang up before the call is completed. Elimination of unpleasantness surrounding calling the cooperating call routing system may thus make the cooperating organization more attractive to potential customers or clients of that organization and increase the number of calls that are completed. Furthermore, reducing the frustration (e.g., due to long waits or a tedious sequence of selections) of callers to the cooperating call routing system may facilitate a calm conversation between the caller and a representative of the cooperating organization that answers the selected destination telephone. Furthermore, a dialer in accordance with embodiments of the present invention may be programmed to operate in many more languages than would be practical in a conventional call routing system based on voice recordings or simulations (thus assisting immigrants, tourists, and callers from abroad in reaching the desired destination telephone).

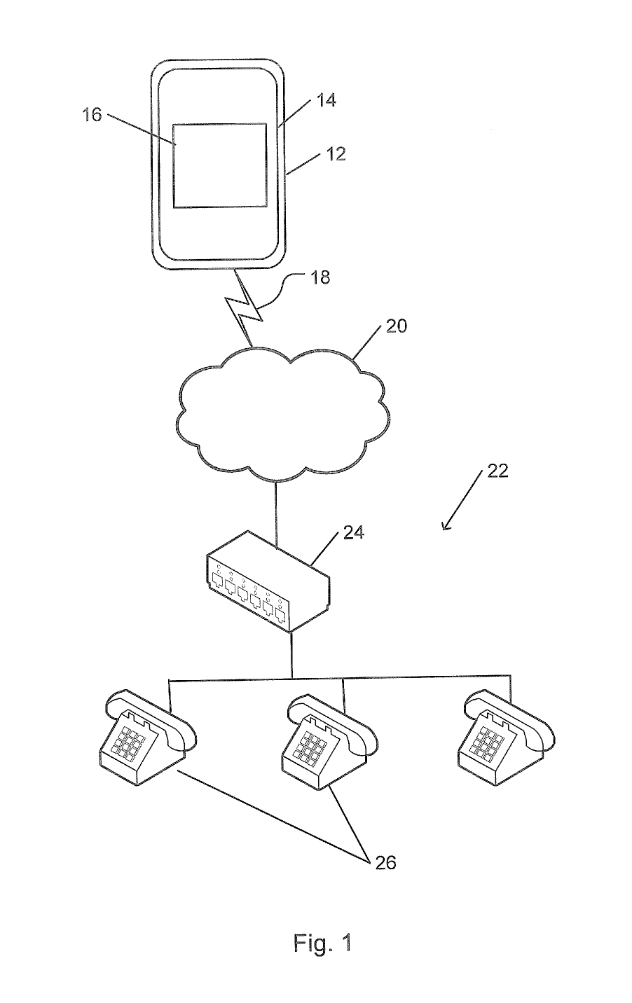

FIG. 1 schematically illustrates a dialer for call routing systems, in accordance with an embodiment of the present invention.

Smartphone 12 may be configured to run a dialer for a call routing system, application in accordance with an embodiment of the present invention. For example, when the dialer is being run, dialer user interface 16 may be displayed on display screen 14 of smartphone 12.

Smartphone 12 is configured to communicate with one or more other devices via communication channel 18 and network 20. For example, communication channel 18 may represent a wireless communication channel (e.g., mobile telephone connection, WiFi connection, or other wireless computer network or telephone connection) or a wired communication channel. Communication channel 18 may represent a combination of two or more separate channels (e.g., each covering a different aspect or segment of communications between smartphone 12 and network 20). Network 20 may represent one or more of a cellular or other mobile telephone network, a telephone network, a computer network, the Internet, or another computer or communication network (e.g., different components of network 20 supporting different segments of communications over network 20).

For example, smartphone 12 may communicate with call routing system 22 via communication channel 18 and network 20. Call routing system 22 is configure to route an incoming call that is received via network 20 to one of destination telephones 26. Call routing system 22 includes call routing device 24. For example, call routing device 24 may be configured to communicate with a caller to select a destination telephone 26 to which a call that is incoming via network 20 is to be connected. Routing device 24 includes appropriate circuitry or electronics components that are capable of connecting the incoming call to one of destination telephones 26 as indicated by the caller. A destination telephone 26 may represent a telephone that is answered by a person, or an automatic answering system (e.g., to enable the caller to make a payment or to provide the caller with recorded information). In some cases, a destination telephone 26 may be accessed directly via network 20 (e.g., by dialing a direct external telephone number that connects an external telephone directly to that destination telephone 26). In other cases, accessing a destination telephone 26 requires routing by routing device 24 (e.g., destination telephone 26 is not connected to a direct line, and is distinguished from other destination telephones 26 only by an extension number that is internal to call routing system 22).

For example, routing device 24 may include an automated telephone exchange or switchboard, e.g., in accordance with standards for the public switched telephone network (PSTN). The automated switchboard may be limited to operation by callers using certain technologies (e.g., Touch-Tone, cellular, or digital signals). A caller may control the automated switchboard, e.g., by pressing a (real or virtual) button on the caller's telephone or by speaking a name or other word or phrase. As another example, routing device 24 may include a router that operates with Voice over Internet Protocol (VoIP) technologies.

Smartphone 12 is configured to run a dialer for a call routing system.

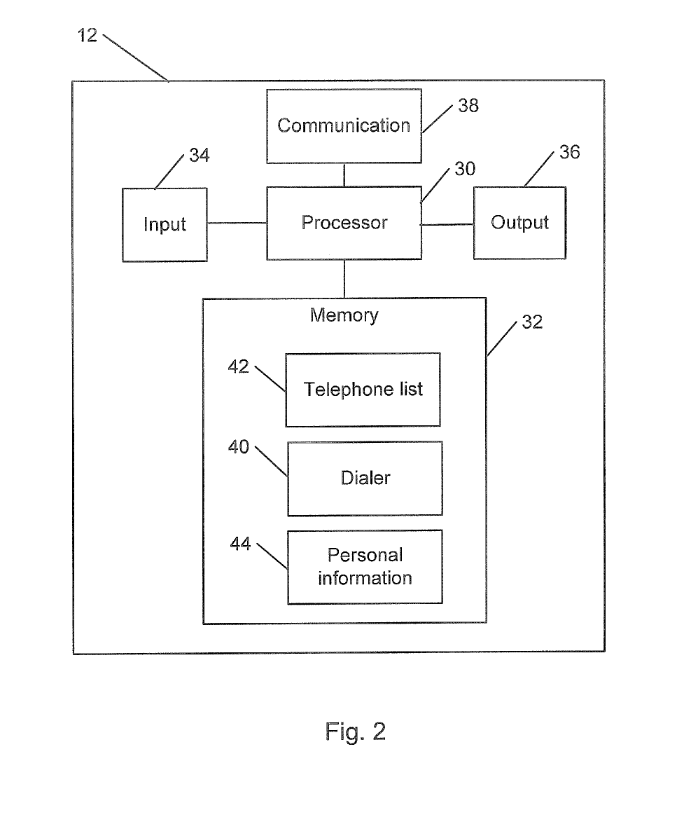

FIG. 2 schematically illustrates a smartphone that is configured to run a dialer for a call routing system, in accordance with an embodiment of the present invention.

Smartphone 12 includes processor 30 that is capable of running or executing the dialer in the form of an application or executable program. Processor 30 includes one or more processing devices. At least some processing devices of processor 30 are local devices that are located within (e.g., inside a case of) smartphone 12. Other processing devices may be located outside of smartphone 12. For example, processing capability of processor 30 may include one or more processing devices that are located remotely from smartphone 12. Such remote processing devices may intercommunicate with local processing devices of processor 30. For example, a remote processing device may be located on a computer to which smartphone 12 is connected via a data cable or data link, or on a device with which smartphone 12 may communicate using a network or other communication channel.

Processor 30 may be configured to operate in accordance with instructions or data that are input by a user via input 34. For example, input 34 may include one or more input devices that enable a user (e.g., a caller) to input data or instructions. Such input devices may include, for example, a touch screen, a keyboard or keypad, a pointing device, a microphone or other sound transducer, a camera or imaging device, or other device that enables input of data or instructions to processor 30.

Processor 30 may be configured to output information or requests for instructions to a user via output 36. Output 36 may include one or more output devices that enable communication in a manner that may be received and comprehended by a user. For example, output devices of output 36 may include a display screen, a speaker, a display panel, an indicator light, or another device that produces visible or audible output.

Processor 30 may be configured to communicate with another device via a communication channel or network via communication unit 38. For example, communication unit 38 may include an appropriate dialer mechanism, pulse generator, tone generator, analog or digital transducer, telephone circuit board, or other component that is capable of sending a telephone signal that is receivable by a telephone. Communication unit 38 may further include a signal receiver that is capable of receiving an analog or digital signal that is sent by a telephone. Communication unit 38 may further include, or communicate with, a connector, port, antenna, emitter, receiver, transceiver, or other component that enables sending or receiving signals via a communication channel or network.

Processor 30 communicates with memory 32. Memory 32 may include one or more volatile or non-volatile memory or data storage devices, or non-transitory computer-readable media. One or more components of memory 32 may be removable from smartphone 12. One or more components of memory 32 may be located remotely to smartphone 12. For example, memory 32 may be considered to include a remotely stored (e.g., on a remote server) database or other data repository that is accessible to processor 30 via a communication channel or network (e.g., accessible via communication unit 38).

Memory 32 may be utilized to store programmed instructions for operation of processor 30, data required for operation of processor 30, or a result of operation of processor 30. Memory 32 may be utilized to serve as a data buffer during communication of processor 30 with another device, or during input or output of data or instructions via input 34 or output 36.

In particular, memory 32 may be utilized to store programmed instructions for execution by processor 30 of dialer application 40.

Memory 32 may be utilized to store telephone list 42. Telephone list 42 includes a list of cooperating organizations or cooperating call routing systems. Telephone list 42 further includes a list of the destination telephones that are associated with each cooperating call routing system. Typically, at least part of telephone list 42 is stored on a remote component of memory 32. For example, a list of destination telephones that are associated with a particular cooperating call routing system may be accessed via a network only after selection by the caller of that cooperating call routing system. Telephone list 42 may include a label or short description (e.g., function) of each destination telephone or group of destination telephones, and instructions or parameters (e.g., direct dial phone number, sequence of selections, access code, or other instructions or parameters) that enable the dialer to connect with each destination telephone. Telephone list 42, or a database that is associated with telephone list 42, may include additional information regarding each destination telephone or group of destination telephones. Such information may include, for example, an availability schedule for the destination telephone, additional information (e.g., caller provided) that is provided by the dialer to enable access to the destination telephone, or other information.

Memory 32 may be utilized to store personal information 44 regarding a caller that uses dialer application 40. For example, personal information 44 may be entered by, or on behalf of, the caller during an initialization or setup phase of dialer application 40. Personal information may be entered using input 34 (e.g., in response to a request that is presented using output 36). For example, personal information may be entered as alphanumeric input using a keyboard, keypad, or pointing device of input 34. Personal information may be entered vocally (e.g., by speaking) using a microphone or other sound transducer of input 34. Personal information may be entered by using a camera or scanner of input 34 to read the personal information that is printed on a document in alphanumeric or encoded (e.g., barcode or two-dimensional barcode) form (e.g., from an identification card, vehicle tag, drivers license, checkbook, certificate, or other document). Personal information 44 may be stored locally, on a component of memory 32 that is incorporated into smartphone 12, or may be remote (e.g., in a database of users of dialer application 40 that is stored in a component of memory 32 on a remote server). Stored personal information 44 may be encrypted, password protected, or otherwise protected from unauthorized access.

A cooperating organization may update information regarding destination telephones as needed. For example, the cooperating organization may provide the information to a service provider that maintains the dialer. Updates may be sent by a server of the service to smartphones on which the dialer is installed. Alternatively or in addition, information regarding destination telephones may be centrally stored (e.g., by the server) and remotely accessed as needed by a smartphone on which the dialer is installed.

Processor 30 may be utilized to execute dialer application 42. Execution of dialer application 42 by processor 30 implements a method for operation of a dialer for a call routing system.

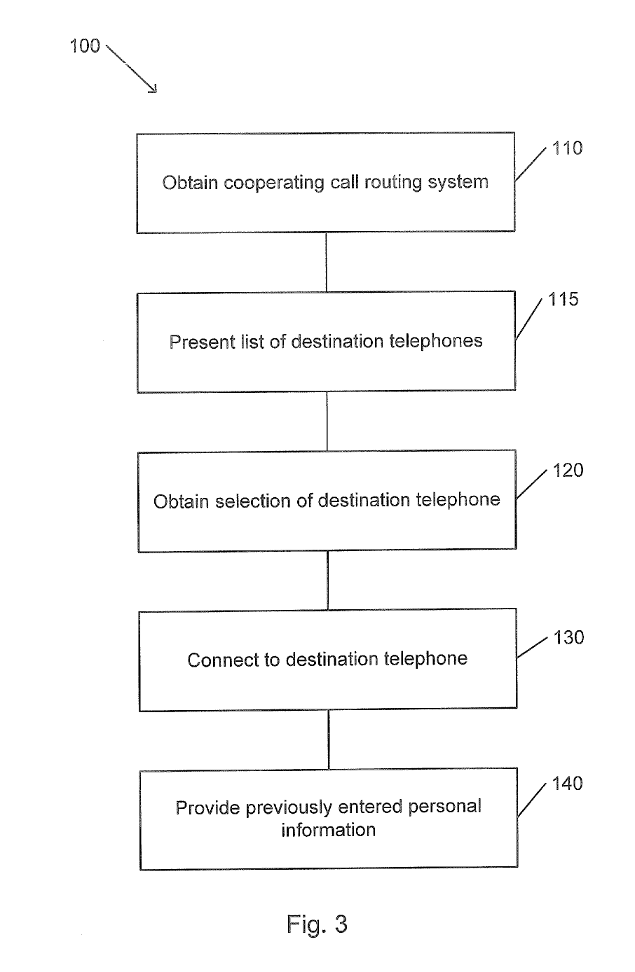

FIG. 3 is a flowchart depicting a method for operation of a dialer for a call routing system, in accordance with an embodiment of the present invention.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Dialer operation method 100 may be executed by a processor of a smartphone when a caller indicates an intention to place a call via the dialer. For example, the caller may select placement of the call via the dialer when the caller knows that placement of the call entails navigating a call routing system. The caller may activate the dialer by selecting an appropriate icon that is displayed by the smartphone, or otherwise activate the dialer (e.g., press a button on the smartphone, speak a command, e.g., “Dial,” into a microphone of the smartphone, or otherwise activate the dialer). In this example, the dialer remains closed or inactive until the dialer is activated by the user.

Alternatively or in addition, the dialer may be active as a background application. The dialer may be configured to automatically detect an indication that the smartphone is to be used to call a cooperating call routing system. For example, a caller may select an organization to be called from a phonebook or contact list of the smartphone, or may select a phone number at a website that is associated with the organization (e.g., organizations website or directory website). The dialer may then automatically identify the selected organization as a cooperating organization. The dialer may then begin execution of dialer operation method 100. As another example, a caller may begin to place a call by entering a phone number. The dialer may automatically recognize the entered phone number as that of cooperating organization. The dialer may then begin execution of dialer operation method 100.

An identification of a cooperation call routing system may be obtained (block 110). For example, a caller may enter all or part of the name of an organization (e.g., company or service) that the caller wishes to call. The dialer may search for the entered name (or for a name that is similar to the entered name) in a database or list of cooperating organizations. If the entered name, or one or more names that are similar to the entered name, is found in the list, the found name is output (e.g., as text or a logo on a display screen, or aloud by a speaker). Alternatively or in addition, the caller may browse a list of cooperating organizations and select an organization from the list. The list may be organized alphabetically, by type of organization (e.g., type of product or service), or otherwise. For example, the list may be organized so as to indicate those organizations that were recently contacted by the smartphone (or by other smartphones that are associated with the caller, or with the caller's family or organization), or that were contacted most often.

If the organization that the caller wishes to call is not a cooperating organization, the dialer may then inform the caller or instruct the caller to call the organization in a conventional manner. Alternatively, the dialer may be configured to assist in calling (e.g., automatic dialing or otherwise) in a conventional manner.

Once the cooperating call routing system is identified, a list of destination telephones associated with that call routing system may be presented to the caller (block 115). For example, the list of destination telephones may be displayed on a display screen of the smartphone. Depending on the size and internal organization of the cooperating call routing system, this list may be present in the form of a simple list, or in the form of a hierarchal tree. As an example of a hierarchal tree, destination telephones may be organized in the form of several groups (e.g., “Sales”, “Service”). When appropriate, selection of a group may cause presentation of a list of subgroups (e.g., selection of “Sales” may result in presentation of various types of products; selection of “Service” may result in presentation of types of service, e.g., “Technical” or “Billing”). When a particular group or subgroup is selected, a list of destination telephones (or more specific subgroups) for the selected group or subgroup is presented. The hierarchal tree may duplicate the order of inputs by a caller that is navigating the call routing system in the conventional manner, or may be reorganized in a manner that is deemed to be more appropriate to the dialer.

A selection of a destination telephone may be obtained (block 120). For example, the caller may select one of the destination telephones from the presented list. The selection may include, for example, touching a touch screen, using a pointing device, scrolling and entering, entering a number or letter, or another manner of selecting.

The dialer may be configured to determine availability of a destination telephone. For example, the cooperating organization may have provided the dialer with a schedule of when some or all destination telephones of the cooperating organization are active. The provided data may be stored in a database that is associated with the list of destination telephones. For example, a destination telephone that is expected to be answered by a person may only be manned during limited working hours. A destination telephone that is automatically answered may not be available during scheduled maintenance. When so configured, the dialer may receive from the cooperating organization updates regarding changes in scheduling, or regarding unscheduled changes in availability. The dialer may access the provided information to determine availability of the destination telephone when the selection of the destination telephone is received.

If the selected destination telephone is determined to be unavailable, the dialer may inform the caller that the destination telephone is not currently available. The dialer may also inform the caller when the destination telephone is to be available. If so configured, the dialer may open a calendar or scheduling application to enable the caller to create a reminder to call again when the caller and the destination telephone are both available. If so configured, the scheduling application may automatically activate the dialer at the scheduled time (e.g., subject to confirmation by the caller) to connect the smartphone to the destination telephone.

The dialer may request additional personal information from the caller once the selection of the destination telephone is received. As used herein, personal information refers to information that identifies a caller or a subject regarding which the caller may call an organization. Personal information may include, for example, a personal identification number, a telephone number, a credit card number, a vehicle registration number, personal information (e.g., age or gender), customer account number, postal code, place or residence, or other information. Any stored personal information may be stored in encrypted form.

For example, the cooperating organization may have provided the dialer with a list of personal information that is to be provided to the call routing system when calling the destination telephone. Such personal information may be related to a function of the destination telephone. For example, if the destination telephone is scheduled to provide a service with regard to a credit card, required personal information may include part or all of the number of the credit card.

Personal information may have been entered by the caller at a time of installation or setup of the dialer. For example, the caller may be requested, at the time of installation or setup, to enter commonly required personal information (e.g., identification number or telephone number). The personal information may have been entered, and thus may be received, in alphanumeric form (e.g., as a typed, entered, scanned, or otherwise entered character string) or in vocal form (e.g., spoken into a microphone). The entered personal information may be saved for use when using the dialer to connect to navigate a call routing system.

In some cases, the dialer may request the caller to enter personal information only when the caller has selected a particular call routing system (as in the operation indicated by block 110) or a destination telephone (as in the operation indicated by block 120). Once the information is entered a first, the personal information may be saved for reuse at a later time.

In some cases (e.g., if an unexpected request is encountered while navigating a call routing system), the caller may be requested to enter personal information during navigation by the dialer of the selected call routing system. The provided information may be stored for later reuse. In this manner, when making subsequent calls to the same destination telephone, the information need not be provided a second time. For example, the dialer may be configured to retrieve the information (e.g., in the form of a string that is created for a particular call) as required.

In some cases, stored information may include several options. For example, a caller or smartphone may be associated with more than one credit card or more than one vehicle, In such a case, the dialer may prompt the caller to select the information that is relevant to the current call (e.g., credit card or vehicle regarding which the caller requires service via the destination telephone. For example, a list of options may be presented to the caller from which the caller is requested to select information to be provided to the call routing system.

If the user fails to select a destination telephone, if the destination telephone is not available, if information required by the call routing system is lacking, or if another circumstance indicates that a call to the destination telephone should not be made (e.g., low power, poor connection, or another circumstance), execution of dialer operation method 100 may then be terminated.

In the absence of an indication that the destination telephone is not available (e.g., no scheduling information was provided, or the scheduling information indicates that the destination telephone is available) or that information is lacking, or of any other indication that a call to the destination telephone should not be made, execution of dialer operation method 100 may continue.

The dialer may then connect the smartphone to the destination telephone (block 130).

For example, if a direct external line (phone number) to the destination telephone exists, the dialer may call the direct line to complete the connection. The caller may not be given access to the direct number. For example, a cooperating organization may prefer not to publish direct numbers to its destination telephones. However, the cooperating organization may be willing to provide the direct number to a dialer that does not display or otherwise enable a caller to learn the direct number.

As another example, the dialer may automatically navigate the call routing system by providing input to the call routing system in the order that such input would be provided by a caller who is calling in the conventional manner. An appropriate interface may be provided in some cases to enable the dialer to navigate the call routing system. For example, the dialer may be configured to provide appropriate input to the call routing system, such as selection of an option, only after the call routing system has responded to an earlier selection. As another example, a cooperating call routing system may be configured with a buffer to hold (e.g., an alphanumeric string that includes a sequence of) several inputs, and capability to parse the inputs (e.g., the alphanumeric string) so as to accept only the relevant portion at each stage of navigating the call routing system. In this case, the dialer may provide a character string with all input upon connecting to the call routing system.

The dialer may provide any previously entered personal information that is required by the call routing system in order to connect the smartphone to the destination telephone (block 140). For example, the dialer may provide the previously entered personal information at a point in navigating the call routing system when that information is required. If a cooperating call routing system is configured with a buffer and capability to parse input, the previously entered personal information may be incorporated into a character string that is provided by the dialer upon connecting to the call routing system. Previously entered personal information may be provided by the dialer to the call routing system in encrypted form.

At any point, the caller may elect to halt execution of the dialer.

If the destination telephone is busy or not immediately available, the caller may be required to wait in a queue until the destination telephone becomes available. If so configured, the dialer may wait for the destination telephone to become available and may notify the caller (e.g., by a ring tone, vibration, flashing, or other action designed to catch the caller's attention) when the smartphone is being connected to the destination telephone. Alternatively or in addition, the cooperating call routing system may be configured to terminate the call while holding the caller's place in the queue, and to notify the dialer to reconnect when the caller reaches the front (or near the front) of the queue.

The dialer may be configured to send a text message, e.g., via fax, Short Messaging Service (SMS), or otherwise, to a destination telephone that is configured to accept such text messages.

1. A method for connecting a smartphone to a telephone via a call routing system, the method comprising:
presenting by the smartphone of a list of destination telephones that are connectible to the smartphone via a selected call routing system;
receiving by the smartphone a selection of a destination telephone from the list of destination telephones;
automatically connecting the smartphone to the selected destination telephone; and
automatically providing previously entered personal information to the selected call routed system.

2. The method of claim 1, wherein obtaining the selection of the call routing system comprises presenting a list of cooperating call routing systems.

3. The method of claim 1, wherein obtaining the selection of the call routing system comprises detecting an indication of an intention to use the smartphone to call that call routing system.

4. The method of claim 3, wherein the indication comprises selection of a telephone number of the selected call routing system from a phonebook of the smartphone.

5. The method of claim 1, further comprising checking availability of the selected destination telephone.

6. The method of claim 5, further comprising generating a notification of when the selected destination telephone is expected to be available.

7. The method of claim 5, further comprising automatically connecting to the selected destination telephone when the selected destination telephone becomes available.

8. The method of claim 1, further comprising presenting a request by the smartphone for entering the personal information.

9. The method of claim 8, further comprising receiving the entered personal information in alphanumeric form or in vocal form.

10. The method of claim 1, wherein a destination telephone of the list of destination telephones is labeled by a label selected from a group of label types consisting of a telephone number, a branch line, a telephone extension, a name of a person, a name of a department, and a name of a service.

11. A smartphone device comprising:
a communication unit to communicate with a telephone; and
a processor configured to:
obtain a selection of a call routing system;
presenting a list of destination telephones that are connectible to the device via the selected call routing system;
receive a selection of a destination telephone from the list of destination telephones;
operate the communication unit to connect the device to the selected destination telephone; and
operate the communication unit to provide previously entered personal information to the selected call routing system.

12. The device of claim 11, wherein the processor is further configured to display a list of cooperating call routing systems on a display of the device.

13. The device of claim 11, wherein the processor is configured to obtain the selection of the call routing system by detecting an input indication of an intention to call that call routing system.

14. The device of claim 11, wherein the processor is configured to obtain the selection of the call routing system by detecting a selection of telephone number of the selected call routing system from a phonebook of the device.

15. The device of claim 11, wherein the processor is further configured to check availability of the selected destination telephone.

16. The device of claim 15, wherein the processor is further configured to generate a notification of when the selected destination telephone is expected to be available.

17. The device of claim 15 wherein the processor is further configured to operate the communication unit to connect the device to the selected destination telephone when the selected destination telephone becomes available.

18. The device of claim 11, wherein the processor is configured to operate an output device to request entering of the personal information.

19. The method of claim 18, wherein the processor is configured to receive the entered personal information in alphanumeric form or in vocal form.

20. The method of claim 11, wherein a destination telephone of the list of destination telephones is labeled by a label selected from a group of label types consisting of a telephone number, a branch line, a telephone extension, a name of a person, a name of a department, and a name of a service.
